(19) United States
(12) Patent Application Publication
(10) Pub. No.: US 2026/0284954 A1
(43) Pub. Date: Sep. 24, 2026

(54) EXTRUSION BLOW-MOULDING MACHINE AND METHOD FOR PRODUCING A HOLLOW BODY

(71) Applicant: ALPLA Werke Alwin Lehner GmbH & Co. KG, Hard (AT)

(72) Inventor: Thomas BOHLE, Alberschwende (AT)

(21) Appl. No.: 19/490,026

(22) PCT Filed: Jun. 6, 2024
(86) PCT No.: PCT/EP2024/065525

§ 371 Date: Dec. 4, 2025

(30) Foreign Application Priority Data
Jun. 7, 2023 (CH) 000599/2023

(51) Int. Cl. B29C 49/04; B29C 49/48; B29C 49/64; B29L 31/00

(52) U.S. Cl. CPC B29C 49/04; B29C 49/6604; B29C 2049/4881; B29C 2049/6606; B29L 2031/7158

(57) ABSTRACT

An extrusion blow-molding machine and a method for producing hollow bodies, in particular bottles (20), are disclosed. The extrusion blow-molding machine comprises an extruder head (30), a blow mold (40) with a cavity (41), and a blowing mandrel (70). In order to cool the hollow body which has been blown, the extrusion blow-molding machine has a cooling mold (60) with a cavity (61) corresponding to the finished hollow body.

The present invention relates to an extrusion blow-molding machine and to a method for producing a hollow body according to the preamble of the independent claims.

Various devices and methods for producing a hollow body are known from the prior art.

Single-layer or multilayer plastic containers, for example made of polyolefins, are often produced in an extrusion blow-molding method, in particular in a parison-based blow-molding method. In this case, an extrusion head, also referred to as an extruder head, is normally used to continuously extrude a plastic parison which can be formed in one or more layers. The plastic parison is introduced in sections into a mold cavity of a blow molding tool, brought into the desired shape by means of a blowing medium introduced at overpressure, cooled, and demolded. The blow molding tool usually consists of two blow mold halves, in each of which one half of the mold cavity is formed. The blow mold halves are periodically opened, closed, and opened again in order to introduce a parison section into the mold cavity and, after inflation, to demold the finished container again. For inflation, a blowing mandrel is provided, which is inserted into the extruded parison. This allows the container to be inflated while simultaneously creating a defined opening.

Polyolefins are typically introduced into the blow mold at a temperature of 180° Celsius with a deviation of up to 20° K. Before demolding the plastic container that has been produced, the blow molding tool must be cooled down at the end of the blow molding process to the point that the shaping of the plastic material is largely completed and no undesired deformations can occur during further processing of the plastic container.

Polyolefins are typically demolded at about 60° to 80° Celsius, wherein the temperature at the neck and bottom is still about 80° to 100° Celsius.

Blow molding tools are usually constructed in a plurality of parts and are mostly made of aluminum or steel or even of non-ferrous metals. The two blow mold halves of a blow molding tool each comprise a molding body, in which at least one mold cavity is formed. The molding body is mounted on a baseplate usually made of steel, which is a component of the closing unit of the blow molding machine. On account of the pressures occurring during the blow molding process, the baseplates and the molding bodies must be relatively solid.

Considering the relatively good thermal conduction properties of the individual components in blow molding tools, it is immediately apparent that the expenditure on the periodic heating and cooling of the blow molding tools must be very high in order to achieve reasonably acceptable cycle times and be able to produce high-quality products at the same time. It is known that the blow molding tool can be heated or cooled by means of a suitable fluid, for example water, which is circulated under pressure in channels, milled grooves, and holes in the blow molding tool. In order to achieve the shortest possible cycle times, the heating/cooling fluid is conducted through the channels, milled grooves, and holes at a relatively high pressure. So that the blow molding tool withstands these high pressures, it must be all the more solid. However, in conjunction with the good thermal conduction properties of the materials used for the blow molding tool, this results in an even higher expenditure on the periodic heating and cooling of the blow molding tool. In addition, the more solid design of the blow molding tool also increases the expenditure required for the periodic opening and closing of the blow mold halves.

A generic device and a method are known from WO 2004/078457 A1. To shorten cycle times, it is suggested to use two blowing mandrels and to arrange them independently of the extruder head. However, this only brings slight improvements in terms of cycle time.

It is therefore an object of the invention to eliminate at least one or more disadvantages of the prior art. In particular, an extrusion blow molding machine, also called an extrusion blow molding machine, for the production of hollow bodies and preferably a corresponding method which makes it possible to reduce the cycle times in the blow mold is to be provided.

This object is achieved by the devices and methods defined in the independent claims. Further embodiments result from the dependent claims.

An extrusion blow molding machine according to the invention for the production of hollow bodies, in particular bottles, comprises an extruder head, a blow molding tool with a cavity and a blowing mandrel. The extrusion blow molding machine has a cooling mold with a cavity corresponding to the finished hollow body for cooling the blown hollow body. In other words, the cooling mold has a contour that corresponds to the complete contour of the finished hollow body, i.e., it is a negative of the finished container body.

The cooling mold is designed in such a way that the container can be subjected to final shaping by means of a blowing pressure. In other words, the cooling mold must completely enclose the container and also withstand increased internal pressure.

The cooling mold is intended for the final shaping of the hollow body.

The blow molding tool can also have multiple cavities, in which case the cooling mold also has multiple cavities. Accordingly, a blowing mandrel is also provided, which is designed in multiple parts, meaning it engages in several cavities simultaneously.

This arrangement makes it possible to divide the cooling process of the container, after it has been inflated, into several sections or phases. In particular, it is possible to carry out part of the cooling process outside the blow molding tool, namely within a separate cooling mold. Accordingly, the time during which the blow molding tool is occupied by the inflated hollow body can be shortened. This shortens the cycle time, so the blow molding tool can be used to form a further hollow body earlier, accordingly.

In addition, a separate cooling mold can be significantly simpler in construction than a blow mold. This is partly due to the fact that lower blowing pressures are necessary inside the hollow body during cooling, and therefore the cooling mold has to absorb less force. Therefore, it can be of simpler design. On the other hand, the cooling mold only needs to have cooling channels. Other elaborate provisions are spared.

Separate cooling is particularly advantageous because the hollow body can be demolded from the blow molding tool while still not cooled. This allows it to remain at a higher average temperature and reduces dead times caused by prolonged cooling or heating. Smaller temperature differences between the individual states also make the device more economical and energy-efficient.

Inside the cooling mold, the warm and still soft container can be subjected to a relatively low blowing pressure, so that it retains or regains its final shape. This blowing pressure can be lower than the blowing pressure during the blowing process itself. This is up to 10 bar, especially 8 bar. The blowing pressure during the cooling process within the cooling mold is usually only half as high and amounts to a maximum of 6 bar, preferably only 4 bar, and in particular less than 4 bar.

It may be provided that at least one additional blowing mandrel is provided.

If a first and a second blowing mandrel are provided, hollow bodies can be inflated alternately. The blowing process is therefore no longer dependent on the occupancy of the blowing mandrel, but can be started independently of the occupancy of the first blowing mandrel. Since a corresponding waiting time is eliminated, the provision of at least one additional blowing mandrel also leads to a reduction in cycle time.

Additionally, it may be provided that the extrusion blow molding machine has at least one further cooling mold. This one is substantially identical to the first cooling method.

Such an arrangement allows for a further reduction in cycle time. In particular, if the cooling, or the second phase of cooling in the cooling mold, takes longer than the blowing and the first phase of cooling of a hollow body, a second blown hollow body can be cooled in the second cooling mold, even though the first cooling mold is still occupied.

Preferably, the cooling mold, or each cooling mold, is radially movable with respect to a longitudinal axis of the extruder head.

The cooling mold can therefore be removed from the working area in relation to the extruder head. Accordingly, the hollow body can be parked at a distance from the work area for the period in which it needs to be cooled. The work area is therefore free to blow a further hollow body and/or to provide a second cooling mold to accommodate a second hollow body.

The longitudinal axis of the extruder head is typically defined by the extrusion direction of the extruded parison. In particular, the extruder head can be moved along the longitudinal axis. In its intended use, the extruder head can therefore move up and down.

Alternatively, it can be provided that the cooling mold, or each cooling mold, is arranged to rotate about an axis of rotation parallel to the longitudinal axis.

The cooling mold or molds can be arranged on a rotating axis analogously to a carousel, so that by rotating the carousel or the cooling molds about the rotating axis by a certain angle, a new cooling mold is always located in the working area.

For example, a hollow body can be transferred to a first cooling mold, then the carousel can be moved until a second cooling mold is in the position of the previous first cooling mold. Subsequently, a second hollow body can be transferred to the second cooling mold.

It is also conceivable that two arrangements of cooling molds are provided, each of which can be rotated about separate axes of rotation. In other words, the cooling molds can be arranged on two carousels, which interlock with each other, analogously to gears. The area of engagement is typically located in the working area of the extruder head. By rotating both carousels synchronously, a cooling mold from the first carousel and a cooling mold from the second carousel can be alternately brought into the working area. The cooling molds can then be fitted with a blown hollow body that needs to be cooled, as appropriate, in the working area.

Additionally or alternatively, it may be provided that the blowing mandrel, or each blowing mandrel, is arranged pivotably about a horizontal axis.

In other words, the blowing mandrel can be pivoted about an axis arranged at right angles to the longitudinal axis.

This makes it possible to align the blowing mandrel on the one hand in the direction of the longitudinal axis and on the other hand to pivot it at right angles thereto. Accordingly, the blowing mandrel, or rather the end of the blowing mandrel, can be pivoted out of the working area.

This makes it possible to arrange the cooling mold or cooling molds statically outside the working area. In typical use, for example, a cooling mold can be arranged on both sides of the extruder head. By simply pivoting the blowing mandrel by −90° or +90°, one of the two cooling molds can be loaded.

Additionally or alternatively, it may be provided that the cooling mold and/or the blowing mandrel, or each cooling mold and/or each blowing mandrel, is axially movable in relation to the longitudinal axis of the extruder head.

This arrangement allows the cooling mold to be inserted between the opened blow mold halves of the blow molding tool and allows the finished blown hollow body, which needs to be cooled, to be transferred to the cooling mold in place.

Preferably, the blow molding tool is designed in multiple parts and in particular has two blow mold halves. These are typically symmetrical. This is especially true if the hollow body to be blown is rotationally symmetrical. For hollow bodies that are asymmetrically designed, the blow mold halves are typically mirror-symmetrical.

The bottom area of blown hollow bodies is often at least partially curved inwards and/or has undercuts. In such cases, the blow molding tool, in addition to two blow mold halves, may have an additional removable bottom, which is typically movable in the longitudinal direction, i.e., axially, so that the hollow body can be demolded without damage. However, especially with bottles, it is possible to do without a movable bottom and to remove bottles with only slight undercuts from the tool using so-called forced demolding.

Similarly, and for the same reasons, the cooling mold is multi-part and in particular has two cooling mold halves. If the blow molding tool has a separate bottom area, a corresponding bottom area is also provided on the cooling mold.

Even with hollow bodies that have been forcibly demolded, a separate bottom area is advantageous because otherwise, when the cooling mold halves are brought together, the corresponding edges of the tool could damage the molding body.

A further aspect relates to a method for producing a hollow body, in particular a bottle, in particular having an extrusion blow-molding machine as described here. The method comprises the steps of:
extruding a parison from an extruder head,
inserting this extruded parison into a blow molding tool,
inserting a blowing mandrel into the extruded parison in the blow molding tool,
inflating the parison to form a hollow body,
demolding the hollow body,
characterized in that the hollow body is placed in a cooling mold after demolding.

This process can shorten the cycle time in the blow mold. By placing the hollow body in a separate cooling mold, part of the cooling process can be carried out outside the blow molding tool. This means it is freed up sooner, and a further hollow body can be blown into the blow molding tool more quickly.

Preferably, the hollow body is placed in the cooling mold together with the blowing mandrel. This ensures that the neck area of the hollow body is not deformed, but remains dimensionally stable.

After the hollow body has been placed in the cooling mold, the mold can be moved radially to the longitudinal axis. This radial movement allows the working area of the extruder head to be released again. It may be provided that the cooling mold or molds are moved linearly out of the working area, or, for example, pivoted out of the working area about a separate axis of rotation.

Additionally or alternatively, it may be provided that after the hollow body is placed in the cooling mold, the mold is moved along its longitudinal axis. This type of movement sequence also allows the cooling mold to be removed from the immediate working area of the extruder head.

Preferably, after demolding the hollow body from the blow molding tool, an extruded parison is again inserted into the blow molding tool and blown into a further hollow body. A corresponding shortening of the cycle time is the result.

It may be provided that at least one other cooling mold is provided simultaneously.

This makes it possible for the second blown hollow body to be demolded from the blow molding tool, even though the cooling process in the first cooling mold is not yet finished and the first cooling mold is still occupied by the first blown hollow body.

Accordingly, in a further step, the second blown hollow body can be demolded and placed into the further cooling mold.

During or after the re-inflation of the further hollow body, the first inflated hollow body can be removed from the first cooling mold and the mold can be made available again to receive a new hollow body.

This measure also shortens the cycle time.

The invention is explained below with reference to schematic figures. In the figures:

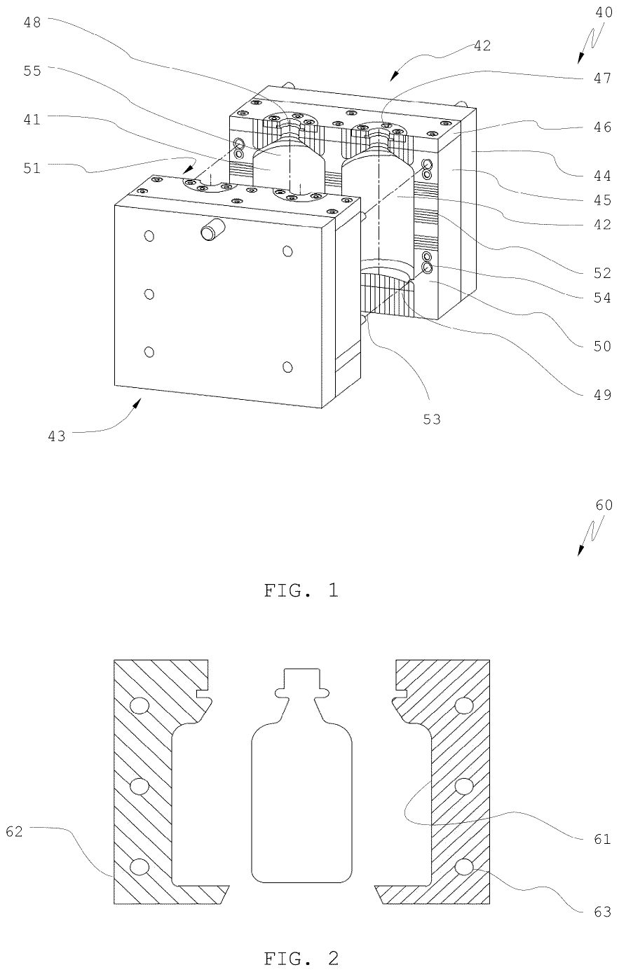

FIG. 1: shows a blow molding tool;

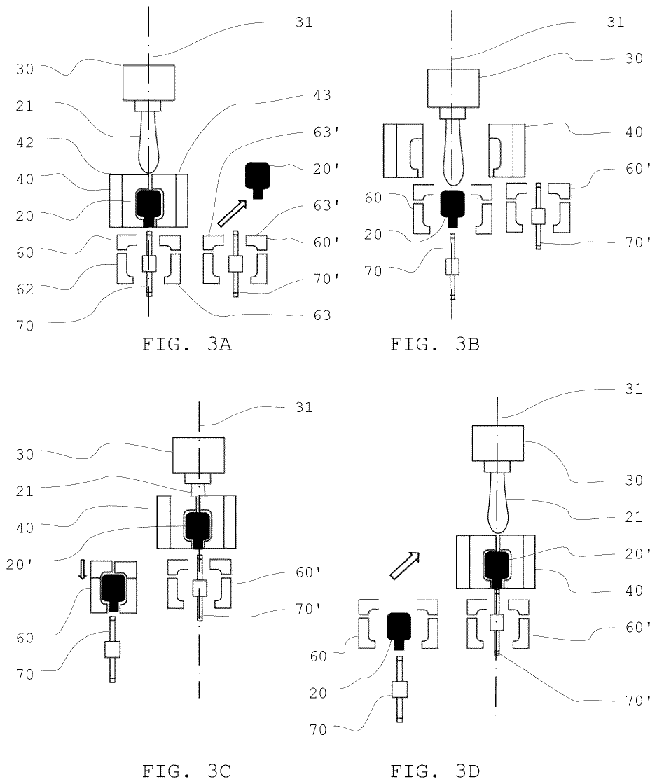

FIG. 2: shows a cooling mold;

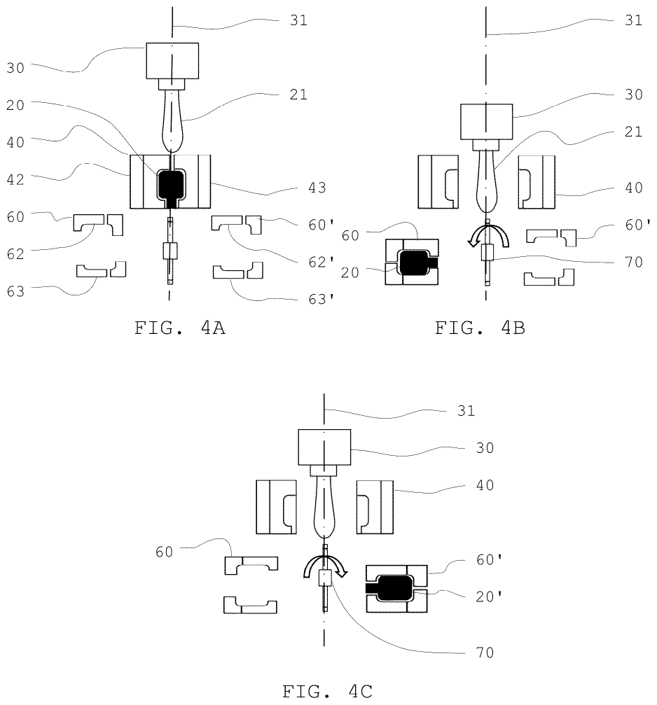

FIGS. 3A to 3D: show individual method steps;

FIGS. 4A to 4C: show an alternative embodiment and the associated method steps.

FIG. 1 shows a blow molding tool 40 to explain the basic structure of such a blow molding tool. The blow molding tool, which as a whole is provided with reference sign 40, comprises a first blow mold half 42 and a second blow mold half 43. In the present case, said blow mold halves are laterally displaceable relative to one another in order to open and close the blow molding tool 40 periodically. Each blow mold half 42, 43 comprises a baseplate 44, which forms part of a closing unit of a blow-molding machine. Mounted on the baseplate 44 is a molding body 45 in which one or more cavities 41 are formed as mold cavities. According to the exemplary embodiment shown, the molding body 45 has two mold cavities, each defining one half of the shape of a body of a plastic container. Since the mold cavities correspond to one another, for better clarity the two mold cavities are not provided with all reference signs, although the explanations apply in each case to both mold cavities.

A head plate 46 is provided with a cavity 47 for defining a neck section of the plastic container. In the case of a blow molding tool for an extrusion blow molding machine, according to the prior art, neck knives 48, which are only indicated in FIG. 1, are also provided on the head plate 46 of the blow molding tool for separating an extruded plastic parison inserted into the blow molding tool 40.

A bottom part 49 closes the mold cavities at the other end of the blow molding tool 40. On the mutually facing surfaces 50, 51 of the blow mold halves 42, 43, which define a separating plane of the blow molding tool 40, venting slots 52 can be formed. On one of the blow mold halves 40, guide pins 53 are formed, which slide into guide bushes 54 of the other blow mold half 42 when the blow mold halves 42, 43 are closed. The molding body 45 has a wall surface, i.e., an inner wall 55, which forms a part of the mold cavity.

The blow molding tool 40 shown in FIG. 1 is configured the way it is typically used in the prior art. A blow molding tool 40 for an extrusion blow molding machine as described herein and a corresponding method is preferably configured as described in WO 2004/078457 A1.

The blow molding tool is used in a position that is rotated 180° upside down to the position shown in FIG. 1. An extruded parison is inserted from above through the bottom towards the top plate.

The blown hollow body is removed from the blow molding tool together with the blowing mandrel, in accordance with the method described herein. Accordingly, no neck knives 48 are provided on the head plate, but separate separating knives are arranged downstream of the blow molding tool 40 in the extrusion direction, so that they can be actuated independently of the blow molding tool.

FIG. 2 shows a cooling mold 60 with a cavity 61 corresponding to the cavity 41 of the blow mold 40. It should also be noted here that, in the generic use, the cooling mold is used in a position that is rotated 180° upside down to the position shown in FIG. 2. The cooling mold 60 has a first cooling mold half 62 and a second cooling mold half 63, which together form the corresponding cavity 61. As can be seen, the cooling mold 60 is relatively simple in design compared to the blow mold 40 from FIG. 1 and only has cooling channels which are not specified in more detail here. The cooling mold 60 according to FIG. 2 can also be significantly less massive, since the forces acting on the cooling mold 60 are significantly lower compared to the forces acting on the blow molding tool 40.

FIGS. 3A to 3D now show method steps for producing a hollow body as described here.

FIG. 3A shows an extruder head 30 from which a parison 21 is extruded. The extruder head 30 has a longitudinal axis 31 which extends accordingly in the extrusion direction of the parison 21. The blow molding tool 40 is located after and below the extruder head 30. The blow molding tool 40 has two blow mold halves 42 and 43 and is closed in this case. Inside the blow molding tool 40 there is already a finished blown hollow body in the shape of a bottle 20. A cooling mold 60 with two cooling mold halves 62 and 63, shown open, is arranged following the blow molding tool 40. Between the cooling mold halves 62 and 63 is a blowing mandrel 70, which extends with its end into the bottle 20. However, this is not shown in detail in the figures presented here.

Also shown is a second cooling mold 60′ with two cooling mold halves 62′ and 63′, which is moved laterally or radially in relation to the longitudinal axis 31. It is also evident that a second bottle 20′ is being demolded from the second cooling mold 60′ in this step, as it is completely chilled.

In the following figures, only the basic elements are provided with reference signs. Accordingly, the elements mentioned but not named in the description can be found in FIG. 3A.

FIG. 3B now shows the next step. The bottle 20, which has not yet completely cooled down, is removed from the blow molding tool 40 together with the blowing mandrel 70. For this purpose, the blow mold halves 42 and 43 are opened. Subsequently, the blowing mandrel 70 is moved together with the bottle 20 in an axial direction along the longitudinal axis 31. The cooling mold 60 is opened accordingly, so that the bottle 20 can be inserted into cooling mold 60, or between the cooling mold halves 62 and 63.

Simultaneously with the blowing mandrel 70, the extruder head 30 including the already extruded parison 21 (see FIG. 3A) also moves in an axial direction along the longitudinal axis 31, so that the further extruded parison 21 can be inserted between the blow mold halves 42 and 43 of the blow molding tool 40.

Subsequently, the extruded parison 21 is separated from the container 20 using knives (not shown here) and the cooling mold 60 is closed. The cooling mold 60 is then moved radially in relation to the longitudinal axis 31 together with the container 20 and the blowing mandrel 70 contained therein. Simultaneously or subsequently, a second cooling mold 60′ together with a second blowing mandrel 70′ is brought into the working area of the extruder head 30, i.e., below the blow molding tool 40.

This situation is shown in FIG. 3C. Simultaneously with the movement of the cooling mold 60, a low blowing pressure can be applied by means of the blowing mandrel 70. This blowing pressure is typically lower than the blowing pressure required when blowing the hollow body. The blowing pressure is in the range of 4 bar in this case. This will be maintained until the bottle 20 has cooled down. This process also gives the bottle its final shape. This step applies equally to all embodiments.

At the same time, the blow mold halves 42 and 43 of the blow molding tool 40 are closed. However, a second blowing mandrel 70′ is inserted into the extruded parison 21 beforehand, so that a corresponding neck forms on the container during the closing of the blow molding tool 40. With the blow molding tool 40 closed, a blowing pressure is introduced through the second blowing mandrel 70′, so that another bottle 20′ is inflated. As can be seen, a second cooling mold 60′ is already positioned below the blow molding tool 40.

FIG. 3D now shows the next step. A parison 21 is still being extruded in the extruder head 30. The extruder head 30 must move upwards along the longitudinal axis 31, i.e., away from the blow mold 40. Inside the blow mold 40, the second bottle 20′ has already partially solidified; therefore, the first phase of a cooling process has already been completed. During this process, the first finished bottle 20 can be demolded from the first cooling mold 60. The method has thus substantially returned to the state described in FIG. 3A, with the difference that the second cooling mold 60′ is now located below the blow molding tool 40 and the finished container is demolded from the first cooling mold 60. The process is now continued as described in FIG. 3A, only with a reversed initial configuration of the cooling molds 60 and 60′.

FIGS. 4A to 4C now show an alternative device for carrying out the method as well as the corresponding method steps. The devices are substantially constructed from the same components as already described in FIG. 3A. For the sake of clarity, only FIG. 4A is provided with all reference signs.

In the following figures, only the basic elements are provided with reference signs. Accordingly, the elements mentioned but not named in the description can be found in FIG. 4A.

FIGS. 4A to 4C show an extrusion blow molding machine, wherein this has a blowing mandrel 70 which is arranged pivotably about a horizontal axis. The horizontal axis is therefore substantially arranged at right angles to the longitudinal axis 31. It extends beyond the plane of the drawing sheet. The blowing mandrel 70 can therefore, with reference to the representation of FIG. 4A, move to the left and to the right, or pivot to the left and right.

FIG. 4A shows the blow molding tool 40. This has two blow mold halves 42 and 43 and is closed in this case. Inside the blow molding tool 40 there is already a finished blown hollow body in the shape of a bottle 20. Below the blow molding tool 40 is a blowing mandrel 70, which extends with its end into the bottle 20. However, this is not shown in detail in the figures presented here.

Above the blow molding tool 40 is the extruder head 30 with an already extruded parison 21.

On both sides of the blow molding tool 40 is a cooling mold 60, 60′ with two cooling mold halves 62, 62′ and 63, 63′, which is shown open.

The bottle 20 from FIG. 4A has already partially cooled down. In the next step, the blow mold halves 42 and 43 are opened and the bottle 20 is removed from the blow molding tool together with the blowing mandrel 70. This can be achieved either by moving the blow molding tool 40 away from the blowing mandrel or by moving the blowing mandrel 70 away from the blow molding tool 40. Subsequently, the extruded parison 21 is cut from the container 20 with knives not shown here, and the blowing mandrel 70 and the horizontal axis are then rotated and the partially cooled bottle 20 is transferred to the cooling mold 60. This situation is shown in FIG. 4B. Simultaneously or subsequently, the extruder head 30 is moved along the longitudinal axis 31 in the direction of the blow molding tool 40, so that the extruded parison 21 can be received between the blow mold halves 42 and 43.

The blow mold halves 42 and 43 of the blow molding tool 40 are then closed. However, the blowing mandrel 70′ is inserted into the extruded parison 21 beforehand, so that a corresponding neck forms on the container during the closing of the blow molding tool 40. With the blow molding tool 40 closed, a blowing pressure is introduced through the blowing mandrel 70, so that another bottle is inflated. As can be seen, the second cooling mold 60′ is already open and ready to receive the further bottle.

After the further bottle has partially cooled, the blow mold halves 42 and 43 are opened and the other bottle, together with the blowing mandrel 70, is removed from the blow molding tool 40. This can be achieved either by moving the blow molding tool 40 away from the blowing mandrel or by moving the blowing mandrel 70 away from the blowing tool 40. Subsequently, the extruded parison 21 is cut from the container 20 with knives not shown here, and the blowing mandrel 70 is then rotated about the horizontal axis in the opposite direction to what was previously described, and the partially cooled bottle is transferred to the second cooling mold 60′. This situation is shown in FIG. 4C. Simultaneously or subsequently, the extruder head 30 is moved along the longitudinal axis 31 in the direction of the blow molding tool 40, so that the extruded parison 21 can be received between the blow mold halves 42 and 43.

The first bottle 20 is then demolded from the first cooling mold 60, so that it can hold a new bottle. The process can now begin again.

For industrial production, it is preferable to provide multiple versions of the individual method steps or plant components and molds in order to produce a large number of products in one work cycle.

1. An extrusion blow-molding machine for producing hollow bodies, in particular bottles (20), comprising an extruder head (30), a blow molding tool (40) with a cavity (41), and a blowing mandrel (70), wherein the extrusion blow molding machine has a cooling mold (60) with a cavity (61) corresponding to the finished hollow body for cooling the blown hollow body.

2. The extrusion blow-molding machine according to claim 1, wherein at least one further blowing mandrel (70) is provided.

3. The extrusion blow-molding machine according to claim 1, wherein at least one further cooling mold (60) is provided.

4. The extrusion blow-molding machine according to claim 1, wherein each cooling mold (60) is radially movable in relation to a longitudinal axis (31) of the extruder head (30).

5. The extrusion blow-molding machine according to claim 1, wherein each cooling mold (60) is arranged to be rotatable about an axis of rotation parallel to the longitudinal axis (31).

6. The extrusion blow-molding machine according to claim 1, wherein each blowing mandrel (70) is arranged pivotably about a horizontal axis.

7. The extrusion blow-molding machine according to claim 1, wherein each cooling mold (60) is axially movable in relation to a longitudinal axis (31) of the extruder head (30).

8. The extrusion blow-molding machine according to claim 1, wherein the blow molding tool (40) has two blow mold halves (42, 43).

9. The extrusion blow-molding machine according to claim 1, wherein the cooling mold (60) has two cooling mold halves (62, 63).

10. A method for producing a hollow body, in particular a bottle (20), comprising the steps of:
extruding a parison (21) from an extruder head (30),
inserting this extruded parison (21) into a blow molding tool (40),
inserting a blowing mandrel (70) into the extruded parison (21) in the blow molding tool (40),
inflating the parison (21) to form a hollow body,
demolding the hollow body,
wherein the hollow body is placed in a cooling mold (60) after demolding.

11. The method according to claim 10, wherein the hollow body is introduced into the cooling mold (60) together with the blowing mandrel (70).

12. The method according to claim 10, wherein the cooling mold (60) is moved radially to the longitudinal axis after the hollow body has been inserted.

13. The method according claim 10, wherein after demolding the hollow body from the blow molding tool (40), an extruded parison (21) is again inserted into the blow molding tool (40) and blown into a further hollow body.

14. The method according to claim 13, wherein a further cooling mold (60) is provided simultaneously.

15. The method according to claim 14, wherein the further hollow body is demolded and placed into the further cooling mold (60).

16. The method according to claim 13, wherein during or after the re-inflation of the further hollow body the cooling mold (60) is demolded and made available to receive a hollow body.
